(19) United States
(12) Patent Application Publication
(10) Pub. No.: US 2023/0193097 A1
(43) Pub. Date: Jun. 22, 2023

(54) HYDROSTABLE SILICONE ADHESIVES

(71) Applicants: Dow Global Technologies LLC, Midland, MI (US); Dow Silicones Corporation, Midland, MI (US)

(72) Inventors: Gang Lu, Freeport, TX (US); Julia Sunderland, Auburn, MI (US); Ryan Thomas, Auburn, MI (US); Cameron J. Kadleck, Bend, OR (US); Duane R. Romer, Midland, MI (US); Nick Shephard, Auburn, MI (US)

(21) Appl. No.: 17/925,686

(22) PCT Filed: Aug. 30, 2021
(86) PCT No.: PCT/US2021/048165

§ 371 Date: Nov. 16, 2022

Related U.S. Application Data
(60) Provisional application No. 63/072,972, filed on Sep. 1, 2020.

(51) Int. Cl. C09J 183/06; C08G 77/18; C08K 5/14

(52) U.S. Cl. CPC C09J 183/06; C08G 77/18; C08K 5/14

(57) ABSTRACT

A curable organopolysiloxane composition contains: (A) 100 mass parts of a functional organopolysiloxane component having at least one radical curable group selected from an acrylate group and a methacrylate group and optionally one or more alkoxysilyl groups; (B) 0 to 100 mass parts of a condensation curable organo polysiloxane component; (C) one to 10 mass parts of tetraalkoxysilanes or a hydrolyate of the tetraalkoxysilanes; and optionally one or more of (D) a radical initiator, (E) a condensation catalyst, (F) fillers, (G) adhesion promoters, (H) pigments, (I) a non-reactive organopolysiloxane, and (J) inhibitors.

The present invention relates generally to silicone adhesive compositions that retains its adhesive strength in a hydrolytic environment.

Adhesive silicone compositions are known and described in, for example, WO2014/124388A1. Such compositions offer satisfactory performance in air. However, water, both in liquid and gaseous form (high humidity) and often in conjunction with high temperature, makes for some of the most hostile environments for adhesives and sealants. For the naval applications, for example, failure of hardware (sonar transducers, hull penetrators, cable connectors, etc.) due to compromised bond between the organic polymer adhesives and the metal is a grave problem. Initial adhesive strength does not predict the failure after exposure to such environments, adhesives for transportation applications where such environment is expected sometimes are required to pass a salt spray test as long as 6 weeks. In such applications, a salt spray test that can last as long as 6 weeks is useful to test adhesion.

Conventionally, hydrolytically stable adhesion is improved two ways. One way of improving adhesion to a metal surface is to treat the metal. Acid etching dramatically improves the water-resistance of the aluminum joints. A second way is to use primers and blocking agents, which can improve the hydrolytic stability of adhesive bonds. Silane coupling agents are widely used for this purpose. One example is DOWSIL™ 1200 OS primer, which can enhance the hydrolytic stability of adhesive bonds to many metals (DOWSIL is a trademark of The Dow Chemical Company). Some compounds of the N-methylene phosphonic acid family have also been identified as a strong blocker for aluminum surfaces to enhance adhesion to aluminum.

However, there is still a need for an adhesive that has a strong and durable adhesive property in a hydrolytic environment, and in particular one that does not require pretreatments and can be used directly to bond metal and plastic surfaces.

### BRIEF SUMMARY OF THE INVENTION

This invention relates to a curable organopolysiloxane composition comprising: (A) 100 mass parts of a functional organopolysiloxane having at least one radical curable group selected from an acrylate group and a methacrylate group and optionally one or more alkoxysilyl groups, and (C) one to 100 mass parts of tetraalkoxysilanes or a hydrolysates thereof, which is an organopolysiloxane containing multiple alkoxysilyl groups.

The curable organopolysiloxane composition may comprise, in addition to component (A) and (C), (B) 0 to 100 mass parts of a condensation curable organopolysiloxane component, which is a reactive organopolysiloxane having at least one condensation curable group when no alkoxysilyl group is present in component (A). The curable organopolysiloxane may further comprise (D) a radical initiator, (E) a condensation cure catalyst, (F) reinforcing fillers, (G) adhesion promoters, (H) pigments, (I) a non-reactive organopolysiloxane, and (J) inhibitors.

The compositions described in the present invention may be utilized in adhesives for transportation and under-water applications. The compositions can be used directly on metals or plastics without chemical etching or priming and still exhibit strong adhesion compared to previously described compositions.

### DETAILED DESCRIPTION OF THE INVENTION

General definitions Percentages are weight percentages (wt %) relative to composition weight unless otherwise stated and temperatures are in ° C., unless specified otherwise. Experimental work is carried out at room temperature (20-25° C.), unless otherwise specified.

A “hydrocarbyl” group is a substituent derived from an aliphatic or aromatic hydrocarbon, which may be linear, branched or cyclic; and which may have one or more substituents selected from halo (preferably fluoro), hydroxyl, alkoxy, alkanoyl, aroyl (aryl attached to carbonyl), aryl, heterocyclic, and substituted or unsubstituted amino (—NRR′, where R, R′ may be hydrogen, hydrocarbyl as defined herein, alkoxy, or heterocyclic). Preferably, hydrocarbyl groups are unsubstituted. A hydrocarbyl group may be an “alkyl,” “alkenyl,” or “aryl.” An “alkyl” group is a substituted or unsubstituted saturated hydrocarbyl group having a linear, branched or cyclic structure. Alkyl groups may have one or more substituents described above for the hydrocarbyl group in general. Preferably, alkyl groups are unsubstituted. Preferably, alkyl groups are linear or branched (that is, the alkyl groups are preferably “acyclic”). An “alkenyl” group is a substituted or unsubstituted hydrocarbyl group having a linear, branched or cyclic arrangement and having at least one carbon-carbon double bond. Preferably, alkenyl groups have no more than three carbon-carbon double bonds, preferably no more than two, preferably one. Alkenyl groups may have one or more substituents described above for the hydrocarbyl group in general. Preferably, alkenyl groups are unsubstituted. Preferably, alkenyl groups are linear or branched (acyclic). An “aryl” group is a substituent derived from an aromatic hydrocarbon which may contain an aliphatic structure as well as aromatic structure. An aryl group may be bonded to the rest of the molecular structure via an aromatic ring carbon atom or via an aliphatic carbon atom. Aryl groups may have one or more substituents described above for the hydrocarbyl group in general. Preferably, aryl groups are unsubstituted. A “heterocylic” group is a substituent derived from a heterocyclic compound, which may be aromatic or aliphatic, and which may comprise more than one ring. Heterocyclic groups may have one or more substituents selected from hydroxyl, alkoxy, alkanoyl, aroyl and aryl, and substituted or unsubstituted amino (—NRR′, where R, R′ may be hydrogen, hydrocarbyl as defined herein, alkoxy, or heterocyclic). Preferably, heterocyclic groups are unsubstituted. An “alkoxy” group is a substituent formed by adding an oxygen atom at the point of attachment of an alkyl group. An “alkoxysilyl” group is an alkoxy group bonded to a silicon atom.

An expression Ca-Cb means a substituent selected from a group of structure having as few as “a” carbon atoms and as many as “b” carbon atoms. Ca-Cb hydrocarbyl, for example, means a hydrocarbyl group having as few as “a” number of carbon atoms and as many as “b” carbon atoms. The number of carbon atoms in such a substituent includes any carbon atoms which may be in substituents thereof. “(Meth)acrylic” and “(meth)acrylate” mean acrylic or methacrylic or mixtures thereof; and acrylate or methacrylate or mixture thereof, respectively. “Acac” means acetylacetonate, acetylacetone, or a mixture thereof, as permitted by constraints due to chemical valence and electron-distribution structure. “DP” means degree of polymerization. “PDMS” means polydimethylsiloxane.

The present invention describes curable adhesive organopolysiloxane compositions that are curable by a heat curing mechanism such as thermal radical initiation and a room temperature curing mechanism such as condensation reaction that maintain its adhesive strength under hydrolytic environment. The present invention may also use a radiation curing mechanism such as radiation radical initiation or redox reaction, or a combination thereof.

In certain embodiments, a curable organopolysiloxane composition is provided that comprises: (A) a functional organopolysiloxane having at least one radical curable group and optionally one or more alkoxysilyl groups, (B) a reactive organopolysiloxane having at least one condensation curable group, and (C) tetraalkoxysilane or a hydrolysate thereof, which is an organopolysiloxane containing multiple alkoxysilyl groups.

Component (A) is a functional organopolysiloxane having at least one radical curable group. The radical curable group is preferably a (meth)acrylate group. The functional organopolysiloxane may further contain one or more alkoxysilyl group. These functional groups may be clustered or telechelic.

Component (A) may be prepared by hydrosilylation reaction of: component (a), an organopolysiloxane component having an average, per molecule, of at least 2 aliphatically unsaturated organic groups; component (b), a reactive species component having, per molecule, at least 1 hydrogen bonded to a silicon atom; in the presence of component (c), hydrosilylation catalyst.

Component (a) may be a combination comprising two or more organopolysiloxanes that differ in at least one of the following properties: structure, viscosity, degree of polymerization, and sequence. Component (a) may have a linear or branched structure, or a mixture of both. Preferably, component (a) has a linear structure.

Component (a) has a minimum average DP of 100. Alternatively, average DP of component (a) may range from 100 to 1000. Component (a) may contain organopolysiloxane having DP of as few as 10, provided that component (a) also contains organopolysiloxanes having DP greater than 100 to give the average DP of at least 100. The distribution of DP of organopolysiloxanes of component (a) can be bimodal. For example, component (a) may comprise one alkenyl-terminated polydiorganosiloxane with a DP of less than 100 (for example 50 to 70, preferably about 60) and another alkenyl-terminated polydiorganosiloxane with a DP higher than 100, provided that average DP of the all polydiorganosiloxanes in component (a) ranges from 100 to 1000. When component (a) has a bimodal distribution, the organopolysiloxane with the lower DP (low DP organopolysiloxane) is present in a lower amount than the organopolysiloxane with the higher DP (high DP organopolysiloxane). For example, in a bimodal distribution, the ratio of low DP organopolysiloxane/high DP organopolysiloxane may range from 10/90 to 25/75.

Component (a) may be linear and may be exemplified by organopolysiloxanes of formula (I), formula (II), or a combination thereof.

R¹₂R₂SiO(R¹₂SiO)ₐ(R¹R₂SiO)_{b}SiR¹₂R² (I)

R¹₃SiO(R¹₂SiO)_{c}(R¹R²SiO)_{d}SiR¹₃ (II)

In these formulae, each R¹ is independently a monovalent organic group free of aliphatic unsaturation, each R² is independently an aliphatically unsaturated organic group, subscript a has an average value ranging from 2 to 1000, subscript b has an average value ranging from 0 to 1000, subscript c has an average value ranging from 0 to 1000, and subscript d has an average value ranging from 4 to 1000. In formulae (I) and (II), 10≤(a+b) ≤1000 and 10≤(c+d) ≤1000.

Suitable monovalent organic groups free of aliphatic unsaturation for R¹ include, but are not limited to, monovalent hydrocarbon groups exemplified by alkyl such as methyl, ethyl, propyl, butyl, pentyl, octyl, undecyl, and octadecyl; cycloalkyl such as cyclohexyl; and aryl such as phenyl, tolyl, xylyl, benzyl, and 2-phenylethyl. Preferably, R¹ is selected from methyl and ethyl. R² may be an aliphatically unsaturated monovalent hydrocarbon group exemplified by alkenyl groups such as vinyl, allyl, propenyl, and butenyl; and alkynyl groups such as ethynyl and propynyl. Preferably, R² is selected from vinyl, allyl, and hexenyl.

Component a) may comprise a polydiorganosiloxane such as: i) dimethylvinylsiloxy-terminated polydimethylsiloxane, ii) dimethylvinylsiloxy-terminated poly(dimethylsiloxane/methylvinylsiloxane), iii) dimethylvinylsiloxy-terminated polymethylvinylsiloxane, iv) trimethylsiloxy-terminated poly(dimethylsiloxane/methylvinylsiloxane), v) trimethylsiloxy-terminated polymethylvinylsiloxane, vi) dimethylvinylsiloxy-terminated poly(dimethylsiloxane/methylphenylsiloxane), vii) dimethylvinylsiloxy-terminated poly(dimethylsiloxane/diphenylsiloxane), viii) phenyl,methyl,vinyl-siloxy-terminated polydimethylsiloxane, ix) dimethylhexenylsiloxy-terminated polydimethylsiloxane, x) dimethylhexenylsiloxy-terminated poly(dimethylsiloxane/methylhexenylsiloxane), xi) dimethylhexenylsiloxy-terminated polymethylhexenylsiloxane, xii) trimethylsiloxy-terminated poly(dimethylsiloxane/methylhexenylsiloxane), or xiii) a combination thereof.

Suitable polydiorganosiloxanes for component (a) are known in the art and are commercially available, for example, under the trade names DOWSIL™ SFD-128 (DP ranging from 800 to 1000), DOWSIL™ SFD-120 (DP ranging from 600 to 700), DOWSIL™ 7038 (DP of 100), and DOWSIL™ SFD-119 (DP of 150). All of these are vinyl-terminated polydimethylsiloxanes are commercially available from The Dow Chemical Company of Midland, Mich., USA. DOWSIL is a trademark of The Dow Chemical Company.

Component (b) is a polyorganohydrogensiloxane component having an average of 4 to 15 silicon atoms per molecule. Component (b) has an average of at least 4 silicon-bonded hydrogen atoms per aliphatically unsaturated organic group in component (a). Component (b) may be cyclic, branched, linear, or a combination thereof. Component (b) may be a combination comprising two or more polyorganohydrogensiloxanes that differ in at least one of the following properties: structure, viscosity, degree of polymerization, and sequence.

Component (b) may be a cyclic polyorganohydrogensiloxane having an average of 4 to 15 siloxanes per molecule. The cyclic polyorganohydrogensiloxane may have formula (III),

(R³₂SiO_{2/2})ₑ(HR³SiO_{2/2})_{f} (III)

in which each R³ is independently a monovalent organic group free of aliphatic unsaturation, subscript e has an average value ranging from 0 to 10, subscript f has an average value ranging from 4 to 15, and a quantity (e+f) has a value ranging from 4 to 15, alternatively 4 to 12, alternatively 4 to 10, alternatively 4 to 6, and alternatively 5 to 6. Monovalent organic groups suitable for R³ include, but are not limited to, monovalent hydrocarbon groups exemplified by alkyl such as methyl, ethyl, propyl, butyl, pentyl, octyl, undecyl, and octadecyl; cycloalkyl such as cyclohexyl; and aryl such as phenyl, tolyl, xylyl, benzyl, and 2-phenylethyl. Preferably, R³ is methyl.

Alternatively, component (b) may be a branched polyorganohydrogensiloxane. The branched polyorganohydrogensiloxane for component (b) may have formula (IV),

Si—(OSiR⁴₂)_{g}(OSiHR⁴)_{g},(OSiR⁴₃)ₕ(OSiR⁴₂H)₍₄₋ₕ₎ (IV)

in which each R⁴ is independently a monovalent organic group free of aliphatic unsaturation, subscript g has a value ranging from 0 to 10, subscript g′ has a value ranging from 0 to 10, and subscript h has a value ranging from 0 to 1. Subscript g may be 0. When subscript g′ is 0, then subscript h is also 0. Monovalent organic groups suitable for R⁴ include, but are not limited to, monovalent hydrocarbyl groups exemplified by alkyl such as methyl, ethyl, propyl, butyl, pentyl, octyl, undecyl, and octadecyl; cycloalkyl such as cyclohexyl; and aryl such as phenyl, tolyl, xylyl, benzyl, and 2-phenylethyl.

Alternatively, component (b) may be a linear polyorganohydrogensiloxane having an average of at least 4 silicon-bonded hydrogen atoms per molecule. The linear polyorganohydrogensiloxane for component (b) may have a formula selected from (V), (VI), or a combination thereof,

R⁵₂HSiO(R⁵₂SiO)ᵢ(R⁵HSiO)ⱼSiR⁵₂H (V)

R⁵₃SiO(R⁵₂SiO)ₖ(R⁵HSiO)ₘSiR⁵₃ (VI)

where each R⁵ is independently a monovalent organic group free of aliphatic unsaturation, subscript i has an average value ranging from 0 to 12, subscript j has an average value ranging from 2 to 12, subscript k has an average value ranging from 0 to 12, and subscript m has an average value ranging from 4 to 12 where 4≤(i+j) ≤13 and 4≤(k+m) ≤13. Monovalent organic groups suitable for R⁵ include, but are not limited to, monovalent hydrocarbyl groups exemplified by alkyl such as methyl, ethyl, propyl, butyl, pentyl, octyl, undecyl, and octadecyl; cycloalkyl such as cyclohexyl; and aryl such as phenyl, tolyl, xylyl, benzyl, and 2-phenylethyl.

Component (a) and Component (b) are capable of undergoing a hydrosilylation reaction through an aliphatically unsaturated organic group of component (a) and a silicon bonded hydrogen atom of component (b). Component (a) and component (b) may be present in amounts sufficient to provide a weight percent of silicon bonded hydrogen atoms in component (b) divided by the weight percent of unsaturated organic groups in component (a) (commonly referred to as SiH_{b}/Viₐ ratio) ranging from 4/1 to 20/1, alternatively 4/1 to 10/1, and alternatively 5/1 to 20/1. Without wishing to be bound by theory, it is thought that if SiH_{b}/Viₐ ratio is 30/1 or higher, the components may crosslink to form a product with undesirable physical properties; and if SiH_{b}/Viₐ ratio is less than 4/1, the product of the process may not have sufficient clustered functional groups to have fast enough cure speed, particularly if a monofunctional reactive species (having one curable group per molecule) is used as component (c).

Component (c) is a reactive species that may be any species that can provide the curable groups in Component (A) the functional organopolysiloxane (i.e., in the reaction product of a reaction of components (a), (b) and (c)). The reactive species has an average, per molecule, of at least one aliphatically unsaturated organic group that is capable of undergoing an addition reaction with a silicon bonded hydrogen atom of component (b). Component (c) further comprises one or more radical curable groups per molecule. The radical curable groups are reactive groups that render the clustered functional organopolysiloxane (prepared by the process described above) radiation curable. The radical curable groups on component (c) may be selected from acrylate groups and methacrylate groups and combinations thereof.

For example, component (c) may comprise a silane of formula (VII),

R⁸ₒSiR⁹₍₃₋ₒ₎ (VII)

in which subscript o has a value ranging from 1 to 3, each R⁸ is independently an aliphatically unsaturated organic group, and each R⁹ is independently selected from an organic group containing an acrylate group and a methacrylate group.

Alternatively, component (c) may comprise an organic compound (which does not contain a silicon atom). The organic compound for component c) may have an average, per molecule, of 1 to 2 aliphatically unsaturated organic groups, such as alkenyl or alkynyl groups, and one or more reactive groups selected from an acrylate group and a methacrylate group. Examples of suitable organic compounds for component (c) include, but are not limited to, allyl acrylate and allyl methacrylate (AMA) and combinations thereof.

The amount of component (c) depends on various factors including the type, amount, and SiH content of component (b) and the type of component (c) selected. However, the amount of component (c) is sufficient to make SiHₜₒₜ/Viₜₒₜ range from 1/1 to 1/1.4, alternatively 1/1.2 to 1.1/1. The ratio SiHₜₒₜ/Viₜₒₜ is the combined weight percent of silicon bonded hydrogen atoms on component (b), chain extender component (g) if present, and endcapper component (h) (described below) if present, divided by the weight percent of aliphatically unsaturated organic groups on components (a) and (c) combined.

Component (d) is a hydrosilylation catalyst which accelerates the reaction of components (a), (b), and (c). Component (d) may be added in an amount sufficient to promote the reaction of components (a), (b), and (c), and this amount may be, for example, sufficient to provide 0.1 parts per million (ppm) to 1000 ppm of platinum group metal, alternatively 1 ppm to 500 ppm, alternatively 2 ppm to 200, alternatively 5 ppm to 20 ppm, based on the combined weight of all components used in the process.

Suitable hydrosilylation catalysts are known in the art and commercially available. Component (d) may comprise a platinum group metal selected from platinum (Pt), rhodium, ruthenium, palladium, osmium or iridium metal or organometallic compound thereof, or a combination thereof. Component (d) is exemplified by chloroplatinic acid, chloroplatinic acid hexahydrate, platinum dichloride, and complexes of said compounds with low molecular weight organopolysiloxanes or platinum compounds microencapsulated in a matrix or coreshell type structure. Complexes of platinum with low molecular weight organopolysiloxanes include 1,3-diethenyl-1,1,3,3-tetramethyldisiloxane complexes with platinum. Alternatively, the catalyst may comprise 1,3-diethenyl-1,1,3,3-tetramethyldisiloxane complex with platinum. When the catalyst is a platinum complex with a low molecular weight organopolysiloxane, the amount of catalyst may range from 0.04% to 0.4% based on the combined weight of the components used in the process.

Suitable hydrosilylation catalysts for component (d) are described in, for example, U.S. Pat. Nos. 3,159,601; 3,220,972; 3,296,291; 3,419,593; 3,516,946; 3,814,730; 3,989,668; 4,784,879; 5,036,117; and 5,175,325 and EP 0 347 895 B.

Component (B) is one or more condensation cure-functionalized organopolysiloxanes and contains at least one hydroxysilyl- or alkoxysilyl group per molecule. Component (B) must be present if component (A) does not contain hydroxysilyl or alkoxysilyl groups. Component (B) may be present in addition to component (A) containing hydroxysilyl- or alkoxysilyl groups. Component (B) may be linear or may be resin-polymer blend. Preferably, the organopolysiloxane of component (B) is a trialkoxysilyl-terminated linear organopolysiloxane polymer, trialkoxysilyl-terminated resin, or a blend of such an organopolysiloxane. Preferably, the organopolysiloxane is trimethoxylsilyl-terminated. More preferably, the organopolysiloxane is a trimethoxysilyl-terminated polydimethylsiloxane. The DP of the organopolysiloxane of component (B) may be as small as 100 up to 2000. Relative to 100 mass parts of component (A), component (B) may comprise any amount including 0 when component (A) contains hydroxysilyl or alkoxysilyl group. Typically, the amount of component (B) may be in the range from 0, 10, 20, 30 and at the same time no more than 40, 50, 60, 70, 80, 90 or 100 parts by mass relative to component (A).

Component (C) is one or more tetra-alkoxysilane or a hydrolysate there of, sometimes shown as poly(diethoxysiloxane) or poly(dimethoxysiloxane), which contains multiple alkoxysilyl groups within silicone. Component (C) may not be a trialkoxysilane, nor may it contain fewer than four alkoxy groups if poly(dialkoxysiloxane) is selected. When component (C) is a tetraalkoxysilane, such tetra-alkoxysilane has a formula

Si(OR¹⁰)₄ (VIII)

wherein R¹⁰ is an alkyl group of 1 to 6 carbon atoms. Component (C) may be a mixture of two or more tetra-alkoxysilanes with different alkyl groups for R¹⁰. Preferably, the tetra-alkoxysilane is tetraethoxysilane. Alternatively, the tetra-alkoxysilane is tetra-n-propoxysilane.

When component (C) is a hydrolysate of tetra-alkoxysilane, the hydrolysate contains polyorganosiloxanes having the structure of formula

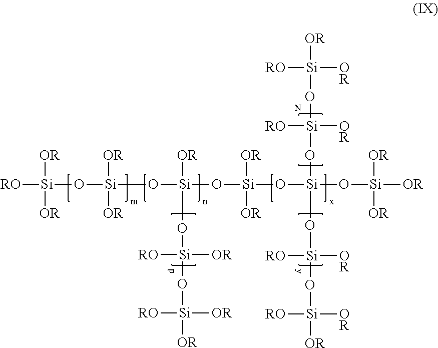

wherein R is independently selected from C₁₋₂₀ alkyl groups, and m, n, p, x, y, z are independently integers in a range of from 0 to 100. The alkoxy group of such tetra-alkoxysilane may be methoxy, ethoxy, propoxy, butoxy and such. Component (C) may comprise poly(diethoxysiloxane) or a poly(dimethoxysiloxane). When component (C) is branched, the branching point, alternatively referred to as “silica”, may comprise 10, 20, 30, 40, 50, 60 or more wt % of the organopolysiloxane. The amount of component (C) relative to the sum of component (A) and component (B) may be as low as 1 wt % but no more than 8 wt %. Preferably, the amount is in the range from 1.2wt % to 5 wt %. The amount of component (C) may be considered in relative molar ratio to trimethoxysilyl function in the composition as a whole. An effective relative molar range of the amount of component (C) is from 2 to 12.

The curable organopolysiloxane composition may further comprise any one or any combination of more than one of the following: (D) a radical initiator, (E) a condensation cure catalyst, (F) reinforcing fillers, (G) adhesion promoters, (H) pigments, (I) a non-reactive organopolysiloxane, and (J) inhibitors. These additional components may be added to the extent that the adhesive characteristics of the curable organopolysiloxane composition is not impaired. Such amounts can be routinely determined by a practitioner of this technology.

Component (D) is a radical initiator, which may be a thermal radical initiator or a room-temperature radical initiator. Typically, azo compounds, organic peroxides and peroxy group-containing compounds are useful as thermal radical initiators. Alternatively, organoborane-amine complexes, a combination of a peroxide and an amine, or a transition metal chelate are useful as room-temperature radical initiators. Radical initiators are readily available from multiple commercial sources.

Peroxides may be alkyl peroxides, diacyl peroxides, ester peroxides, and carbonate peroxides. Examples of alkyl peroxides include dicumyl peroxide, di-tert-butyl peroxide, di-tert-butylcumyl peroxide, 2,5-dimethyl-2,5-di(tert-butylperoxy)hexane, 2,5-dimethyl-2,5-di(tert-butylperoxy)hexyne-3, tert-butylcumyl, 1,3-bis(tert-butylperoxyisopropyl)benzene, and 3,6,9-triethyl-3,6,9-trimethyl-1,4,7-triperoxonan. Examples of diacyl peroxides include benzoyl peroxide, lauroyl peroxide, and decanoyl peroxide.

Examples of ester peroxides include 1,1,3,3-tetramethylbutylperoxyneodecanoate, α-cumylperoxyneodecanoate, tert-butylperoxyneodecanoate, tert-butylperoxyneoheptanoate, tert-butylperoxypivalate, tert-hexylperoxypivalate, 1,1,3,3-tetramethylbutylperoxy-2-ethylhexanoate, tert-amylperoxyl-2-ethylhexanoate, tert-butylperoxy-2-ethylhexanoate, tert-butylperoxyisobutyrate, di-tert-butylperoxyhexahydroterephthalate, tert-amylperoxy-3,5,5-trimethylhexanoate, tert-butylperoxy-3,5,5-trimethylhexanoate, tert-butylperoxyacetate, tert-butylperoxybenzoate, and di-butylperoxytrimethyladipate.

Examples of carbonate peroxides include di-3-methoxybutyl peroxydicarbonate, di(2-ethylhexyl)peroxydicarbonate, diisopropyl peroxycarbonate, tert-butyl peroxyisopropylcarbonate, di(4-tert-butylcyclohexyl)peroxydicarbonate, dicetyl peroxydicarbonate, and dimyristyl peroxydicarbonate. In particular, 4,4′-bis(methylbenzoyl) peroxide is useful in the composition of the present invention.

Organoborane-amine complexes may be formed between an organoborane and a suitable amine compound that renders the complex stable at ambient conditions. An example is a hydrocarbyl amine complex formed from trihydrocarbylboranes and various amine compounds. While the preferred molar ratio can vary, the optimal molar ratio may range from 1 to 10 nitrogen groups per boron atom. The hydrocarbyl part may be linear and branched aliphatic or aromatic hydrocarbon groups containing 1 to 20 carbon atoms. Some examples include trimethylborane, tri-n-butylborane, tri-n-octylborane, tri-sec-butylborane, tridodecylborane, and phenyldiethylborane. Examples of amine compounds useful to form the organoborane amine complex with the organoborane compounds include 1,3 propane diamine, 1,6-hexanediamine, methoxypropylamine, pyridine, and isophorone diamine, as well as silicon-containing amine compounds such as aminoalkylalkoxysilane or terminal and/or pendant amine-functional polydimethylsiloxane oligomers and polymers.

While not limited thereto, the amount of component (D) is preferably within the range of from 0.01, 0.05, 0.1, or 1 part by mass and at the same time up to 15, 10, or 5 parts by mass, with regard to 100 parts by mass of the amount of component (B) reactive organopolysiloxane. Alternatively, the amount of component (D) is within the range of 0.05 to 10 parts by mass, alternatively within the range of 0.05 to 5 parts by mass, and alternatively within the range of 0.01 to 5 parts by mass, of the amount of component (B).

Component (E) is a condensation reaction catalyst, also called condensation cure initiator or moisture cure initiator. Suitable condensation reaction catalyst may be a Lewis acid; a primary, secondary, or tertiary organic amine such as hexylamine or an acetate or quaternary salt of an amine; a metal oxide or a carboxylic acid salt of a metal; a titanium compound which may be a chelated titanium compound, titanium ester or titanate; a tin compound; a zirconium compound; or a combination thereof. Examples of the condensation catalysts include tetraisopropyl titanate, tetrabutyl titanate, tetraoctyl titanate, titanium acetic acid salts, titanium diisopropoxybis(acetylacetonate), and titanium diisopropoxybis(ethyl acetoacetate); zirconium tetraacetylacetonate, zirconium hexafluoroacetylacetonate, zirconium trifluoroacetylacetonate, tetrakis(ethyltrifluoroacetylacetonate)zirconium, tetrakis(2,2,6,6-tetramethyl-heptanedionate), zirconium dibutoxybis(ethylacetoacetate), and zirconium diisopropoxybis(2,2,6,6-tetramethyl-heptanedionate); dibutyltin dilaurate, dimethyltin dineodecanoate, dibutyltin diacetate, dimethylhydroxy(oleate)tin, dioctyldilauryltin, and stannous octoate. Particularly useful for the compositions described herein are bis(ethyl acetoacetato-01,03)-bis(isopropan-1-olato)titanium, in methyltrimethoxysilane (TDIDE/MTM=80%:20% wt) and Zirconium(IV) acetylacetonate (Zr(acac)₄) dispersion.

The amount of the condensation reaction catalyst is not particularly limited and depends on various factors including the type of catalyst selected and the choice of the remaining components in the composition, however the amount of the condensation reaction catalyst typically may range from 0.001% to 5%, preferably in a range of 10 to 1,000 ppm, in a range of 10 to 500 ppm, or in a range of 10 to 300 ppm, in mass unit, based on the weight of the sum of component (A) and component (B), or alternatively may be based on the weight of the reactive resin and polymer of component (B) when (B) is present.

Component (F) may be any known reinforcing fillers, including quartz, fumed silica, or calcium carbonate. The particle size or the amount of the filler is not particularly limited and may be selected based on the desired consistency. Filler particles may be treated by filler treating agents for higher loading or improved wettability of the adhesive composition. The amount of component (F) may be determined by any practitioner based on the desired physical characteristics of the composition as a whole, but it may be any amount from 0 to as high as 98 wt % of the composition as a whole. Typically, the amount is in the range from 1, 10, 20, 50 wt % and at the same time no more than 60, 70, 80, 95, 97, or 98 wt %.

Component (G) is one or more adhesion promoters. Adhesion promoters are generally known in the art, and may be alkoxysilanes, with amino, thiols, epoxy, (meth)acrylates, and other functions. Although component (C) of the present composition may be described as an adhesion promoter, component (G) is one or more compounds that differ from component (C). An organosilicon compound having at least one silicon atom-bonded C1-C8 alkoxy group per molecule is preferable as this adhesion imparting agent, such as methoxy, ethoxy, or methoxyethoxy group, with a methoxy group particularly preferable. An organosilicon compound may have halogen substituted or unsubstituted monovalent C1-C16 hydrocarbyl groups; epoxy or acrylic modified groups such as 3-glycidoxypropyl group and a 4-glycidoxybutyl group or a 2-(3,4-epoxycyclohexyl)ethyl group, a 3-(3,4-epoxycyclohexyl)propyl group, 3,4-epoxybutyl group and a 7,8-epoxyoctyl group; acryl group-containing monovalent hydrocarbyl groups such as a 3-methacryloxypropyl group; and hydrogen atoms. As such, the adhesion promoter compound preferably has a group reactive with an alkenyl group or a silicon atom-bonded hydrogen atom in this composition, and specifically, preferably has a silicon atom-bonded hydrogen atom or an alkenyl group. Moreover, it preferably has at least one epoxy group-containing a monovalent organic group per molecule. Structurally, such adhesion promoter may be an organosilicon compound including an organosilane compound, an organosiloxane oligomer, and an alkyl silicate. The molecular structure may be linear, branched to various degrees, cyclic, or a network structure. Linear, branched, and network structures are preferred. Examples are silanes such as 3-glycidoxypropyl trimethoxysilane, 2-(3,4-epoxycyclohexyl)ethyl trimethoxysilane, and 3-methacryloxypropyl trimethoxysilane; siloxanes with at least one of silicon atom-bonded alkenyl group or silicon atom-bonded hydrogen atom, and at least one silicon atom-bonded alkoxy group per molecule, and mixtures of any of the foregoing. In particular, octyltriethoxysilane, 3-methacryloxypropyl-trimethoxysilane, or 3-glycidoxypropyltrimethoxysilane is useful. The amount of component (G) is not particularly limited, but may be in the range from 0, 0.01, 0.05, 0.1, 0.5 and at the same time up to 1, 2, or 5 wt % relative to the composition as a whole.

Component (H) is a pigment such as carbon black, iron oxide, or any other colorant that does not significantly interfere with the main function of the composition.

Component (I) is a non-functionalized, non-reactive organopolysiloxane polymers or oligomers. Typically, a polydimethylsiloxane of various DP may be added to adjust viscosity, flowability and other physical characteristics that affect the handleability of the composition. The amount of component (I) is not particularly limited, but may be in the range from 0, 1, 5, 10, 20, 30, 40, 50 and at the same time up to 60, 70, 80wt % relative to the composition as a whole. Typically the amount of component (I) is no more than 10, 20, or 50 wt %.

Component (J) is an inhibitor of polymerization reaction, such as antioxidant butylated hydroxytoluene (BHT). Polymerization inhibitors are known in the art and used to increase shelf-life, control the polymerization speed, and suppress unwanted reactions. The amount of component (J) is easily determined by a skilled artisan.

### EXAMPLES

These examples are intended to illustrate the invention to one of ordinary skill in the art and should not be interpreted as limiting the scope of the invention set forth in the claims. The following components were used in the examples described below.

Stability of Adhesive Bond—Boeing Wedge Test. The stability of adhesive bond was assessed by the Boeing Wedge Test, as described in AS™ D 3762 and ISO 10354. In the test, a specimen is prepared by sandwiching an adhesive between two substrates of the same material and dimension and curing. A wedge is inserted in between the two substrates (now adherends) into the cured adhesive. The distance between the wedge tip to the crack tip within the adhesive and the thickness of the wedge determine the stress applied to the adhesive. To provide a hydrolytic environment, the wedged specimen is either immersed in water at room temperature. The displacement by the wedge causes a crack to develop at the adhesive-adherend interface. The length of adhesive failure after the exposure to water or vapor is used as a proxy for the hydro-stability of the adhesive-metal interface. To concentrate the fracture energy at the substrate of interest, a sharp pre-crack is formed at this interface. In the examples, the sharp pre-crack is formed by placing a thin layer of polyetrafluoroethylene (PTFE) tape between the substrate of interest and the adhesive. Additionally, to cause the fracture to occur only at the interface of the test substrate, the non-target substrate was bonded more strongly to the adhesive by priming it before applying the adhesive.

Preparation of Specimens. The test substrates were 5052 aluminum (Q-lab.com, West Lake, Ohio, USA) and glass-fiber reinforced polybutylene terephthalate (PBT, Rocholl GmbH, Aglasterhausen, Germany) The surface of the substrate pieces (2.54×10.16 cm) was cleaned by toluene and isopropanol and dried in air. For primed substrates, DOWSIL™ OS1200 primer was applied with an automated spray coater. To form a wedge specimen, an adhesive formulation to be tested was dispensed by an automated Nordson EFD Precision Dispenser™ onto a horizontally placed unprimed substrate, the adhesive formulation being applied as a bead having 2mm width and 61-63 mm length. A PTFE tape was used to create the crack tip. The bond line is controlled by spacers (16 gauge wires, about 1mm in diameter) at the head and the foot of the substrate. A primed substrate, unless otherwise noted, was pressed onto the substrate with the adhesive bead. The sandwich structure was cured on a conveyor oven at 125° C. for 5 minutes. The adhesive sandwich was further post-cured at 20±2° C. and 50% relative humidity for designated time to give a test specimen.

Test Protocol. The wedges were inserted into a test specimen at a designate time to create roughly 20% strain. Then, the test specimens with the wedges were submerged in water for a designated time at room temperature. The specimens were removed from water and mechanically opened. The length of adhesive failure, in terms of the length of the adhesive failure, was measured and recorded. Typically, 3-5 replicates were made for each formulation.

Preparation of Methacryloxy-Functional Organopolysiloxane (I). A mixture of methylated silicate (30% wt) in vinyl terminated polydimethylsiloxane (70% wt, DP=800-1000; Dow Silicones Corporation) (3802.3 g), 1-methacryloxypropyl-1,1,3,3-tetramethyldisiloxane (197.8 g; Dow Silicones Corporation), and BHT (1.2 g) was stirred in a 10 L Turello mixer for 15 min or until homogeneous at room temperature under nitrogen. After addition of a Pt-catalyst (2.4 g, Karstedt catalyst in vinyl terminated polydimethylsiloxanes, with Pt concentration=0.5% wt), the reaction was stirred for 1 hour at 70° C. The material was cooled to room temperature under stirring. Complete conversion of the converter was confirmed using 1H NMR spectrometry.

Preparation of Methacryloxy-Functional Organopolysiloxane (II). A mixture of fumed silica (30% wt) in vinyl terminated polydimethylsiloxane (70% wt, DP=800-1000; Dow Silicones Corporation) (3802.0 g), 1-methacryloxypropyl-1,1,3,3-tetramethyldisiloxane (138.5 g; Dow Silicones Corporation), and BHT (1.0 g) was stirred in a 10 L Turello mixer for 15 min or until homogeneous at room temperature under a nitrogen. After addition of a Pt-catalyst (2.2 g, Karstedt catalyst in vinyl terminated polydimethylsiloxanes, with Pt concentration=0.5% wt), the reaction was stirred for 1 hour at 70° C. The material was cooled to room temperature under stirring. Complete conversion of the converter was confirmed using 1H NMR spectrometry.

Preparation of MB1. In a 10-L Turello mixer, the following ingredients were mixed: methacryloxy-functional organopolysiloxane (I) 1661.6 g, quartz filler MIN-U-SIL-5 (US Silica) 1480 g, iron oxide pigment BA33 (Cathay Industries USA) 8.4 g, treating agents octyltriethoxysilane 7.8 g and 3-methacryloxypropyltrimethoxysilane 1.8 g, and were stirred for 10 min under a nitrogen atmosphere. The blend was mixed for 1 h at 70° C. using tempered water. After cooling the mixture to under 50° C. and scraping the blades, the temperature was increased to 80° C. and the blend was heated for 1 h at 50 Torr. Methacryloxy-functional organopolysiloxane (I) 704.4 g were further added and mixed thoroughly for 10 min.

Preparation of Adhesive Formulation A. In a SpeedyMixer® cup, MB1 47.7 g and a free radical initiator 50% 4,4′-bis(methylbenzoyl) peroxide in PDMS (mBPO paste; Akzo Nobel) 1.15 g were combined. An adhesion promoter 4.5 g (see Table 1 below) was added. The mixture was blended by hand and by the SpeedyMixer until thoroughly blended. Finally, the condensation catalysts, 80 wt % bis (ethyl acetoacetato-01,03)-bis (is opropan olato)titanium, in methyltrimethoxysilane (TDIDE/MTM; Dorf Ketal) 0.05 g and 97 wt % Zirconium(IV) acetylacetonate (Zr(acac)4; Sigma-Aldrich) dispersion in silicone 0.10 g, were added, mixed thoroughly again. The formulations were de-aired under vacuum for 5 min using a vacuum chamber and transferred into 55-mL Nordson EFD tubes.

TABLE 1
Adhesion promoters

| | | |
|---|---|---|
| AP1 | TEOS (tetraethoxysilane) | 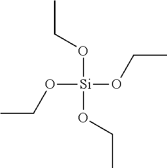 |
| AP2 | DynaSil P (tetra-n- propoxysilane) | 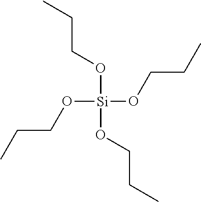 [SMILES: CCCO[Si](OCCC)(OCCC)OCCC] |
| AP3 | MTM (methyl- trimethoxysilane) | 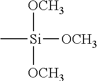 |
| AP4 | MTE (Methyl- triethoxysilane) | 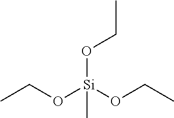 |
| AP5 | Dimethyl diethoxysilane | 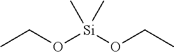 |
| AP6 | MTM dimers | 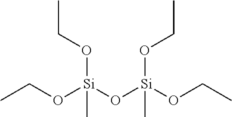 [SMILES: CCO[Si](C)(OCC)O[Si](C)(OCC)OCC] |

The formulations were tested on 5052 Aluminum alloy substrate pieces. Table 2 below summarizes the average and the standard deviation of the length of adhesive failure in millimeters (mm) after 24 hours in water for formulation A. Larger length of adhesive failure indicates lower hydrolytic stability of the adhesive bonds.

TABLE 2
Adhesive failure of adhesion promoters

| | Adhesive failure (Average length/standard | | | |
|---|---|---|---|---|
| Days post cure and | deviation, mm) | | | |
| Wedge Insertion | 1 | 3 | 5 | 7 |
| AP1 | 30/9 | 38/9 | 38/23 | 7/7 |
| AP2 | 54/3 | 20/4 | 20/11 | 5/5 |
| AP3 | 61/2 | 60/0 | 61/1 | 58/1 |
| AP4 | 55/1 | 52/1 | 50/7 | 58/4 |
| AP5 | 60/3 | 58/4 | 58/2 | 58/3 |
| AP6 | 57/1 | 52/3 | 58/2 | 60/0 |

Preparation of Adhesive Formulation B. In a SpeedyMixer™ cup, methacryloxy-functional organopolysiloxane (II) 46.5 g, polydimethylsiloxane 6.44g, iron oxide pigment BA33, and a trimethoxysilyl-terminated polydimethylsiloxane (DP=800-1000; Dow Silicones Corporation) 14.0 g were combined and mixed. An adhesion promoter or a combination of adhesion promoters (see Table 3), then mBPO paste 1.64 g were added. The mixtures were blended by hand and the SpeedyMixer until thoroughly blended. Finally, the condensation catalyst TDIDE/M™ 0.07 g was added and mixed thoroughly again. The formulations were de-aired under vacuum for 5 min using a vacuum chamber and transferred into 55-mL Nordson EFD tubes.

TABLE 3
Adhesion Promoters

| | GPS | TEOS | GPS + AEA | MTM | BH |
|---|---|---|---|---|---|
| I | 0.42 g | 0.84 g | — | — | — |
| II | 0.42 g | — | — | — | — |
| III | 1.26 g | — | — | — | — |
| IV | 0.42 g | — | 0.84 g | — | — |
| V | 0.42 g | — | — | 0.84 g | — |
| VI | 0.42 g | — | — | — | 0.84 g |

GPS=glycidoxypropyltrimethoxysilane; TEOS=tetraethoxysilane; GPS+AEA=Glycidoxypropyl-trimethoxysilane: 3-(2′-aminoethylamino)propyltrimethoxy-silane=3:1wt; MTM=methyltrimethoxysilane; BH=1,6-bis(trimethoxysilyl)hexane

The formulations were tested on 5052 Aluminum alloy and PBT substrate pieces. Table 4 below summarizes the average and the standard deviation of the length of adhesive failure after 24 hours in water for formulation B. Larger length of adhesive failure indicates lower hydrolytic stability of the adhesive bonds.

TABLE 4
Adhesive failure of adhesion promoters

| | Aluminum | | | PBT |
|---|---|---|---|---|
| | Days post cure/Time of Wedge Insertion | | | |
| | 0/0 | 1/0 | 7/0 | 7/0 |
| | Adhesive failure (Average length/standard | | | |
| | deviation, mm) | | | |
| I (+TEOS) | 0/0 | 0/0 | 0/0 | 0/0 |
| II (+none) | 63/0 | 63/0 | 63/0 | — |
| III (more GPS) | 63/0 | 63/0 | 63/0 | — |
| IV (+GPS + AEA) | 63/0 | 63/0 | 63/0 | — |
| V (+MTM) | 63/0 | 63/0 | 63/0 | — |
| VI (+BH) | 63/0 | 63/0 | 63/0 | — |

Preparation of Adhesive Formulation C. In a SpeedyMixer® cup, methacryloxy-functional organopolysiloxane (II) 57.0 g, polydimethylsiloxane 9.2 g, a resin-polymer blend 9.6g (trimethoxysilylated silicate 35% wt in trimethoxysilyl-terminated polydimethylsiloxane 65% wt, DP=500-700, Dow Silicones Corporation), and trimethoxysilyl-terminated polydimethylsiloxane (DP=800-1000; Dow Silicones Corporation) 20.0 g were mixed. An adhesion promoter 3-glycidoxypropyl-trimethoxysilane (Dow Silicones Corporation) 0.6 g and adhesion promoter hydrolysates 1.2g (see Table 5) were added, then mBPO paste 2.3 g were added. The mixtures were blended by hand and the SpeedyMixer until thoroughly blended. Finally, the condensation catalyst TDIDE/M™ 0.18 g was added and the mixture was mixed thoroughly again. The formulations were de-aired under vacuum for 5 min using a vacuum chamber and transferred into 55-mL Nordson EFD tubes.

Hydrolyzates of tetramethoxysilane or tetraethoxysilane are commercially available from Gelest, Inc., Morrisville, Pennsylvania, USA and used as received. These materials contain hydrolysates of tetramethoxysilane (50% silica) and tetraethoxysilane (40-47% silica). Hydrolysate of tetraethoxysilane (40-47% silica) is also available from Wacker Chemie AG, Adrian, Mich., USA, as Wacker® TES 40 WN.

TABLE 5
Adhesion promoter hydrolysates

| | |
|---|---|
| AP1 | TEOS tetraethoxysilane |
| Hydro 1 | Gelest PSI-021, Poly(diethoxysiloxane), 40-42% SiO₂ |
| Hydro 2 | Gelest PSI-026, Poly(dimethoxysiloxane), ~50% SiO₂ |
| Hydro 3 | Gelest PSI-023, Poly(diethoxysiloxane), 45-47% SiO₂ |

The formulations were tested on 5052 Aluminum substrate pieces. Table 6 summarize the average and the standard deviation of the length of adhesive failure after 24 hours in water for formulation C. Larger length of adhesive failure indicates lower hydrolytic stability of the adhesive bonds.

TABLE 6
Hydrolysates as TEOS alternative

| | Aluminum | | |
|---|---|---|---|
| | Days post cure/Time of Wedge Insertion | | |
| | 0/0 | 1/0 | 7/0 |
| | Adhesive failure | | |
| | (Average length/standard deviation, mm) | | |
| AP1 | 0/0 | 0/0 | 0/0 |
| Hydro 1 | 0/0 | 5/8 | 0/0 |
| Hydro 2 | 0/0 | 0/0 | 0/0 |
| Hydro 3 | 10/8 | 9/9 | 0/0 |

Preparation of Adhesive Formulation D. In a SpeedyMixer™ cup, methacryloxy-functional organopolysiloxane (II) 50.2 g, trimethylsilyl-terminated polydimethylsiloxane (viscosity=12500 cSt, Dow Silicones Corporation) 9.2 g, a resin-polymer blend 9.6 g (trimethoxysilylated silicate 35% wt in trimethoxysilyl-terminated polydimethylsiloxane 65% wt, DP=500-700, Dow Silicones Corporation) 9.6 g, and a trimethoxysilyl-terminated polydimethylsiloxane (DP=800-1000; Dow Silicones Corporation) 20.0 g were mixed. 3-Glycidoxypropyl-trimethoxysilane (Dow Silicones Corporation) 0.6 g and TEOS in the amount shown in Table 7 were added. mBPO paste 2.3 g were added, followed by TDIDE/M™ 0.18 g. The mixture was blended by hand and by the SpeedyMixer. The formulations were de-aired under vacuum for 5 min using a vacuum chamber and transferred into 55-mL Nordson EFD tubes.

The formulations were tested using 5052 aluminum substrate pieces, which were both unprimed. Table 7 summarizes the average and the standard deviation of the length of adhesive failure after 24 hours in water for formulation D.

TABLE 7
Loading of TEOS

| | Molar ratio of | Days post cure/Time of Wedge | |
|---|---|---|---|
| | TEOS to | Insertion | |
| TEOS wt % | trimethoxysilyl | 0/0 | 1/0 |
| in total | function in | Adhesive failure | |
| composition | formulation | (Average length/standard deviation, mm) | |
| 0.5% | 1.5 | 19/9 | 9/15 |
| 1.2% | 3.5 | 0/0 | 0/0 |
| 3% | 8.7 | 0/0 | 0/0 |
| 4% | 11.6 | 0/0 | 0/0 |
| 8% | 14.5 | 0/0 | 21/36 |

1. A curable organopolysiloxane composition comprising:
(A) 100 mass parts of a functional organopolysiloxane component having at least one radical curable group selected from an acrylate group and a methacrylate group and optionally one or more alkoxysilyl groups;
(B) 0 to 100 mass parts of a condensation curable organopolysiloxane component;
(C) one to 10 mass parts of tetraalkoxysilanes or a hydrolysate of the tetraalkoxysilanes;
further optionally comprising one or more of
(D) a radical initiator,
(E) a condensation reaction catalyst,
(F) fillers,
(G) adhesion promoters,
(H) pigments,
(I) a non-reactive organopolysiloxane, and
(J) inhibitors.

2. The curable organopolysiloxane composition of claim 1, wherein component (B) is present and is one or more organopolysiloxanes having at least one condensation curable group per molecule.

3. The curable organopolysiloxane composition of claim 2, wherein component (B) is a trimethoxysilyl-terminated linear organopolysiloxane polymer, trimethoxysilyl-terminated resin, or a blend of such polymer and resin.

4. The curable organopolysiloxane composition of claim 1, wherein component (C) is one or more tetraalkoxysilanes having the formula)
Si(OR¹⁰)₄
wherein R¹° is an alkyl group of 1 to 6 carbon atoms; or hydrolysates of the said tetraalkoxysilanes having the formula 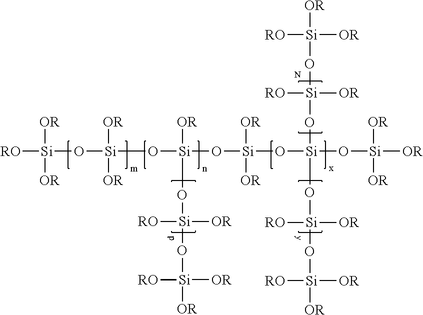
wherein R is independently selected from C₁₋₂₀ alkyl groups, and m, n, p, x, y, z are independently integers from 0 to 100.

5. The curable organopolysiloxane composition of claim 4, wherein component (C) is a tetraethoxysilane.

6. The curable organopolysiloxane composition of claim 1, wherein component (D) is present and is a peroxide radical initiator.

7. The curable organopolysiloxane composition of claim 1, wherein component (E) is present and is a catalyst for silicone condensation.
